(19) United States
(12) Patent Application Publication
(10) Pub. No.: US 2024/0374938 A1
(43) Pub. Date: Nov. 14, 2024

(54) RESPIRATOR DEVICES AND FOLDING PATTERNS FOR RESPIRATOR FILTERS

(71) Applicant: Honeywell Safety Products USA, Inc., Charlotte, NC (US)

(72) Inventor: Juan Carlos Adib Audelo Navarro, Mexico City (MX)

(21) Appl. No.: 18/315,102

(22) Filed: May 10, 2023

(51) Int. Cl. A62B 23/02; A62B 7/10

(52) U.S. Cl. CPC A62B 23/02; A62B 7/10

(57) ABSTRACT

Respirator devices, filters, and/or the like are provided. In some embodiments, a respirator device may include a housing comprising a first half and a second half, wherein the second half defines one or more slots. In some embodiments, the respirator device may include a filter disposed within the housing and configured to remove particulate matter from a fluid medium as it passes through the filter, wherein the filter is folded such that it defines a plurality of parallelograms. In some embodiments, the parallelograms may be dimensioned such that the filter is folded into a Miura pattern.

### TECHNICAL FIELD

The present disclosure relates generally to respirator filters. In particular, it relates to folding patterns for filters in air purifying respirators.

### BACKGROUND

Air purifying respirators (APRs) and powered air purifying respirators (PAPRs) utilize various filters to protect users from various environmental hazards, contaminants, and pollutants to which they may be exposed. Filters must be of a certain size to maximize their effectiveness in the respirator. Smaller filters may concentrate the filtered matter in too small of an area, reducing the filter's lifespan. However, increasing the size of the filter may increase the size and/or weight of the respirator and may become uncomfortable for a user when the respirator is attached to a facepiece for use.

Through applied effort, ingenuity, and innovation, Applicant has solved problems relating to respirator filters by developing solutions embodied in the present disclosure, which are described in detail below.

### SUMMARY

In general, embodiments of the present disclosure provide respirator devices, filters, and/or the like.

In accordance with various embodiments of the present disclosure there is provided a respirator device including a housing having a first half and a second half, wherein the second half defines one or more slots; a filter disposed within the housing and configured to remove particulate matter from a fluid medium as it passes through the filter, wherein the filter is folded such that it defines a plurality of parallelograms.

In some embodiments, the plurality of parallelograms are dimensioned such that the filter is folded into a Miura pattern.

In some embodiments, the plurality of parallelograms are dimensioned such that the filter is folded into a herringbone tessellation.

In some embodiments, the filter is a disc.

In some embodiments, a diameter of the disc is 56 millimeters.

In some embodiments, the filter is composed of fiberglass, paper, or cloth.

In some embodiments, the respirator device is an air purifying respirator or a powered air purifying respirator.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is an exploded view of an example respirator device in accordance with various embodiments of the present disclosure;

FIG. 2 is an isometric view of an example filter for a respirator device in accordance with various embodiments of the present disclosure; and

FIG. 3 is a top plan view of an example respirator device in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments, a respirator (powered or non-powered) may include a housing having a first half and a second half. In some embodiments, the first half may be a bottom half and the second half may be a top half, and the first and second halves may be detachable from each other. In some embodiments, a filter may be placed within the housing, either within the first half, the second half, or partially in either half.

In some embodiments, the filter for a respirator may be folded in a variety of patterns intended to optimize filtering of particulate matter while reducing overall size of the filter. In some embodiments, the filter may be folded such that the crease pattern of the filter generates a plurality of parallelograms on the surface of the filter. In some embodiments, the plurality of parallelograms may have angles ranging between 84 degrees and 96 degrees.

### Example Respirator Devices and Filters

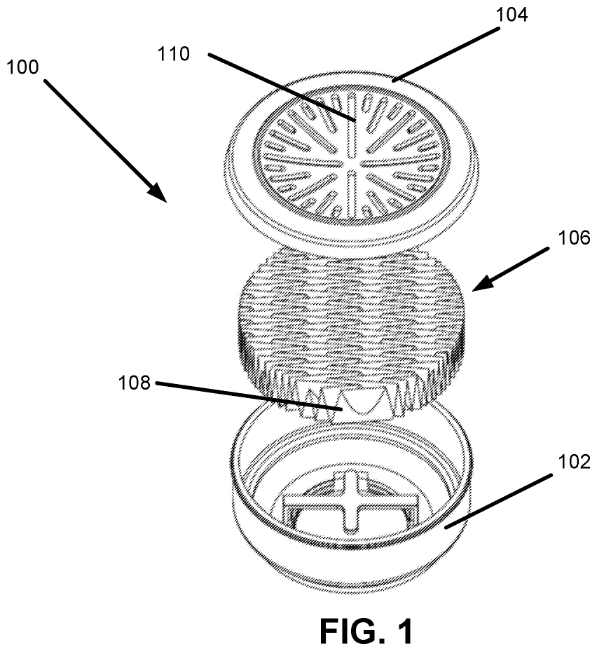

FIG. 1 shows an exploded view of an example respirator device 100, according to various embodiments. In some embodiments, the respirator device 100 may be configured to attach to a facepiece or similar apparel that may be worn by a user. The respirator device 100 may be powered or non-powered, as desired.

In some embodiments, the respirator device 100 may include a housing having a first half 102 and a second half 104. In some embodiments, the first half 102 may be a hollow, substantially cylindrical component, as shown in at least FIG. 1. In some embodiments, the second half 104 may be substantially circular and configured to fit on top of the first half 102. In some embodiments, the first and second halves 102, 104 may be configure to snap-fit or slot together to form the housing. In some embodiments, the first and second halves 102, 104 may be attached via one or more fasteners (e.g., screws or clips).

In some embodiments, an example respirator device 100 may include a filter 106. In some embodiments, the filter 106 may be a particulate filter configured to remove particulate matter containing one or more hazards, contaminants, or pollutants from a fluid medium (e.g., air) as the fluid medium passes through the filter 106. In some embodiments, the filter 106 may be porous and composed of semi-permeable paper. In some embodiments, the filter 106 may be composed of fiberglass, or of pleated paper or cloth.

In some embodiments, the filter 106 may be folded into one or more configurations. In some embodiments, once folded, the filter 106 may be substantially circular or disc-shaped. In some embodiments, the filter 106 may be folded to optimize the surface area of the filter 106 to the volume occupied in the respirator device 100 by the filter. In some embodiments, when the filter 106 is folded such that it is substantially circular or disc-shaped, the filter 106 may have a diameter ranging between 50 and 60 millimeters. In some embodiments, the filter 106 may have a diameter of 56 millimeters.

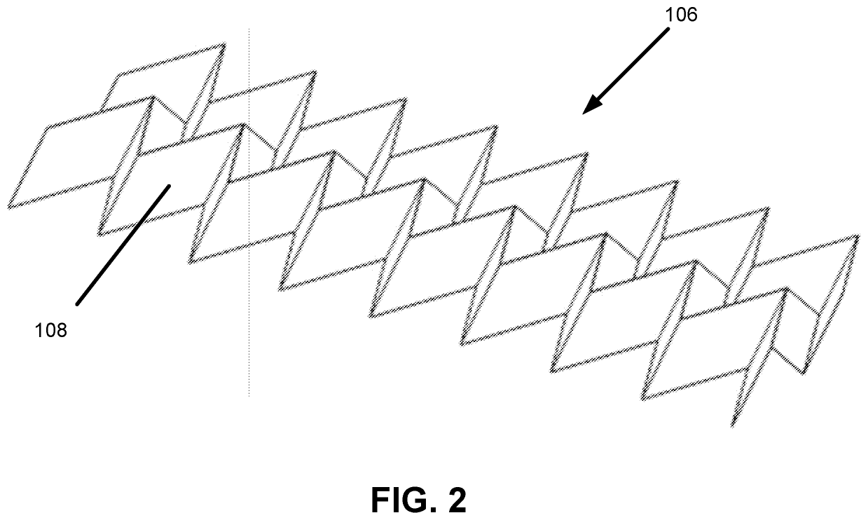

In some embodiments, the filter 106 may be folded such that dimensions of the filter 106 are compressed in one or more dimensions. As shown in greater detail in at least FIG. 2, the filter 106 may be folded such that it defines a plurality of parallelograms 108. In some embodiments, the parallelograms 108 may be identical, and in some embodiments they may be separately dimensioned. In some embodiments, the parallelograms 108 may have angles ranging between 84 and 96 degrees. In some embodiments, the filter 106 may be folded such that the plurality of parallelograms form a Miura pattern. In some embodiments, the filter 106 may be folded such that the plurality of parallelograms form a herringbone tessellation. In some embodiments, the filter 106 may be folded such that the plurality of parallelograms 108 form an accordion-like folding pattern. In some embodiments, the filter 106 may be used in devices other than respirators, including HVAC systems.

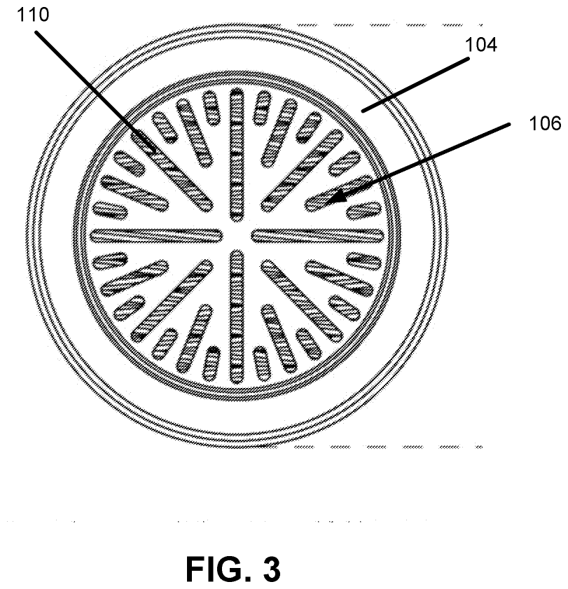

In some embodiments, and as shown in at least FIG. 3, the second half 104 may include one or more slots 110. In some embodiments, the one or more slots 110 may be configured to allow air to pass through and be purified or decontaminated by the filter 106. In some embodiments, the one or more slots 110 may be distributed in a variety of patterns on the second half 104.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A respirator device comprising:
a housing comprising a first half and a second half,
wherein the second half defines one or more slots;
a filter disposed within the housing and configured to remove particulate matter from a fluid medium as it passes through the filter,
wherein the filter is folded such that it defines a plurality of parallelograms configured to optimize a ratio of a surface area of the filter to a volume of the filter.

2. The respirator device of claim 1, wherein the plurality of parallelograms are dimensioned such that the filter is folded into a Miura pattern.

3. The respirator device of claim 1, wherein the plurality of parallelograms are dimensioned such that the filter is folded into a herringbone tessellation.

4. The respirator device of claim 1, wherein the filter comprises a disc.

5. The respirator device of claim 4, wherein a diameter of the disc comprises 56 millimeter.

6. The respirator device of claim 1, wherein the filter is composed of fiberglass, paper, or cloth.

7. The respirator device of claim 1, wherein the respirator device is an air purifying respirator or a powered air purifying respirator.
